(19) United States
(12) Patent Application Publication
(10) Pub. No.: US 2021/0004534 A1
(43) Pub. Date: Jan. 7, 2021

(54) VECTORIZATION DEVICE AND LANGUAGE PROCESSING METHOD

(71) Applicant: Panasonic Intellectual Property Management Co., Ltd., Osaka (JP)

(72) Inventor: Kaito MIZUSHIMA, Hyogo (JP)

(21) Appl. No.: 17/028,743

(22) Filed: Sep. 22, 2020

Related U.S. Application Data
(63) Continuation of application No. PCT/JP2019/004603, filed on Feb. 8, 2019.

(30) Foreign Application Priority Data
Mar. 27, 2018 (JP) 2018-060518

(51) Int. Cl. G06F 40/289; G06N 3/04; G06F 40/284; G06F 40/263

(52) U.S. Cl. CPC G06F 40/289; G06F 40/263; G06F 40/284; G06N 3/04

(57) ABSTRACT

A vectorization device generates a vector according to a text. The vectorization device includes an inputter, a memory, and a processor. The inputter acquires a text. The memory stores vectorization information indicating correspondence between a text and a vector. The processor generates a vector corresponding to an acquired text based on the vectorization information. The vectorization information sets order having a predetermined cycle to a plurality of vector components included in a generated vector.

### BACKGROUND

### 1. Technical Field

The present disclosure relates to a vectorization device that generates a vector corresponding to a text, a language processing method and a program that perform language processing based on a text.

### 2. Related Art

“Convolutional Neural Networks for Sentence Classification” (arXiv preprint arXiv:1408.5882, 08/2014) by Kim Yoon (hereinafter, referred to as non-patent literature 1) discloses a model of a convolutional neural network (CNN) trained for a task of classifying sentences in machine learning. The CNN model of the non-patent literature 1 is provided with one convolutional layer. The convolutional layer generates a feature map by applying a filter to concatenation of word vectors corresponding to a plurality of words in a sentence. The non-patent literature 1 employs word2vec, which is a publicly-known technique using machine learning, as a method for obtaining word vectors for a sentence to be classified.

### SUMMARY

The present disclosure provides a vectorization device and a language processing method capable of facilitating language processing by a vector according to a text.

A vectorization device according to an aspect of the present disclosure generates a vector according to a text. The vectorization device includes an inputter, a memory, and a processor. The inputter acquires a text. The memory stores vectorization information indicating correspondence between a text and a vector. The processor generates a vector corresponding to an acquired text based on vectorization information. The vectorization information sets order having a predetermined cycle to a plurality of vector components included in a generated vector.

A language processing method according to an aspect of the present disclosure is a method for a computer to perform language processing based on a text. The present method includes, acquiring, by a computer, a text, and generating, a processor of the computer, a vector corresponding to an acquired text based on vectorization information indicating correspondence between a text and a vector. The present method includes executing, by the processor, language processing by a convolutional neural network based on a generated vector. The processor sets order having a predetermined cycle to a plurality of vector components included in a generated vector based on vectorization information, to input the generated vector to the convolutional neural network.

According to the vectorization device and the language processing method of the present disclosure, language processing using a vector according to a text can be easily performed based on a cycle of each vector.

### BRIEF DESCRIPTION OF THE DRAWINGS

FIG. 1 is a diagram for explaining an outline of a language processing method according to a first embodiment of the present disclosure;

FIG. 2 is a block diagram exemplifying a configuration of a vectorization device according to the first embodiment;

FIGS. 3A and 3B are a diagram for explaining a data structure of a word vector dictionary in the vectorization device;

FIG. 4 is a diagram for explaining classification of vocabulary in a word vector dictionary;

FIG. 5 is a flowchart exemplifying the language processing method according to the first embodiment;

FIG. 6 is a diagram for explaining a network structure of a CNN according to the first embodiment;

FIG. 7 is a flowchart for explaining processing of a CNN in the first embodiment;

FIGS. 8A to 8C are diagrams for explaining convolution of a CNN in the first embodiment;

FIG. 9 is a diagram showing an experimental result of the language processing method according to the first embodiment;

FIG. 10 is a flowchart exemplifying calculation processing of a word vector according to the first embodiment;

FIGS. 11A and 11B are a diagram for explaining the calculation processing of a word vector according to the first embodiment;

FIG. 12 is a flowchart exemplifying processing of determining a vocabulary list;

FIG. 13 is a flowchart for explaining a variation of the calculation processing of a word vector; and

FIG. 14 is a diagram for explaining a variation of the calculation processing of a word vector.

### DESCRIPTION OF EMBODIMENTS

Hereinafter, an embodiment will be described in detail with reference to the drawings as appropriate. However, description that is detailed more than necessary may be omitted. For example, detailed description of an already well-known matter and redundant description of substantially the same configuration may be omitted. This is to avoid unnecessary redundancy in the description below and to facilitate understanding of those skilled in the art.

Note that the applicant provides the accompanying drawings and the description below so that those skilled in the art can fully understand the present disclosure, and do not intend to limit the subject matter described in claims by these drawings and description.

### Insight to Present Disclosure

The insight for the inventor to achieve the present disclosure will be described below.

The present disclosure describes a technique for applying a convolutional neural network (CNN) to natural language processing. The CNN is a neural network mainly used in a field of image processing such as image recognition (see, e.g., JP 2018-026027 A).

The CNN for image processing convolves an image that is a subject of the processing by using a filter having size of several pixels, for example. The convolution of the image results in a feature map which two-dimensionally shows a feature value for each filter region corresponding to the size of the filter in the image. It is known that the CNN for image processing is able to improve performance by deepening such as convolving a generated feature amount map further.

In the CNN for natural language processing, conventionally, a filter has size including a plurality of word vectors each of which corresponds to a word, and thus an obtained feature map is one-dimensional (see, e.g., non-patent literature 1). The inventor focuses on the fact that the above filter is too large to deepen the CNN, and studies to use a filter of a smaller size. As a result, a problem below is unveiled.

That is, in the CNN for natural language processing, the filter smaller than that of a conventional case causes a filter region to divide the interior of a word vector. However, a conventional word embedding method such as word2vec is hard to find the significance of using such local filter region dividing the interior of a word vector as a unit to be processed. In view of the above, a problem is unveiled that the CNN for natural language processing is difficult to improve performance by deepening.

As to the above problem, the inventor makes great study, resulting in achieving a vectorization method with periodicity in the order for arranging vector components in a word vector. According to the present method, significance can be provided to a local filter region with a small filter according to the periodicity of a word vector, and thereby improvement in performance of the CNN can be achieved.

### First Embodiment

A first embodiment of a vectorization device and a language processing method based on the above vectorization method will be described below.

### 1. Configuration

### 1-1. Outline

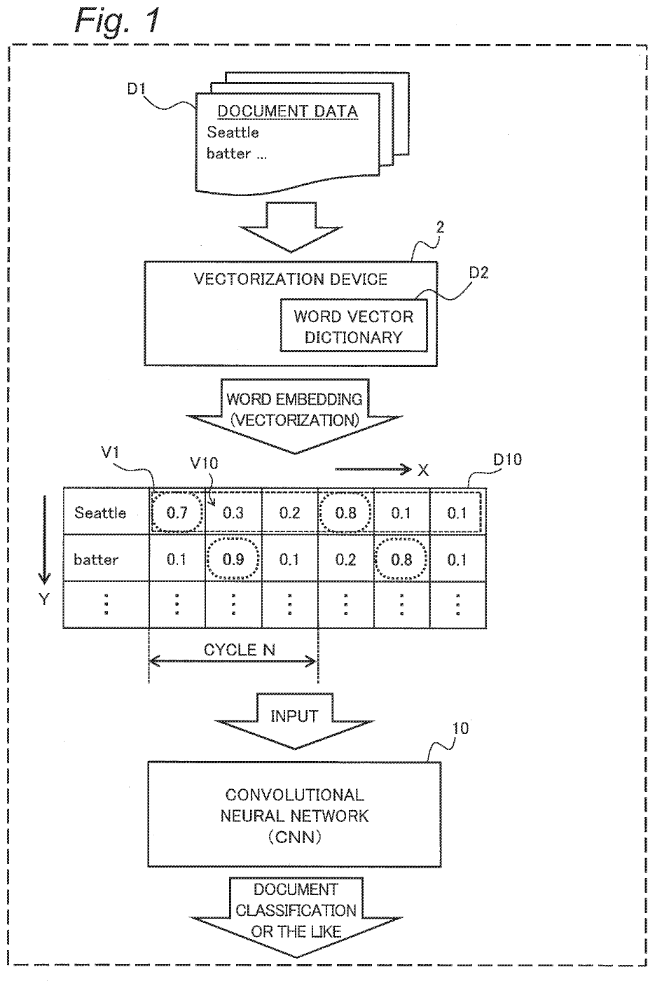

An outline of a language processing method using the vectorization device according to the first embodiment will be described with reference to FIG. 1. FIG. 1 is a diagram for explaining an outline of the language processing method according to the present embodiment.

The language processing method according to the present embodiment uses a CNN 10 for natural language processing in machine learning to perform document classification on document data D1, for example. The document data D1 is text data that includes a plurality of words that constitute a document. A word in the document data D1 is an example of a text in the present embodiment.

A vectorization device 2 according to the present embodiment applies a vectorization method described above to the document data D1 as preprocessing of the CNN 10 in a language processing method. The vectorization device 2 performs word embedding, that is, vectorization of a word in the document data D1 to generate a word vector V1. The word vector V1 includes vector components V10 as many as dimensions set in advance. The word vectors V1 corresponding to different words may be identified by a difference in values of at least one vector component V10.

Document data D10 after preprocessing by the vectorization device 2 is data indicating an array of two-dimensional vector components V10 in X and Y directions, as shown in FIG. 1. The X direction is a direction in which the vector components V10 are arranged in each of the word vector V1. The Y direction is a direction in which the word vectors V1 are arranged in the document data D1, for example.

The vectorization device 2 of the present embodiment, referring to a word vector dictionary D2 for example, sets an order for arranging the vector components V10 with a cycle N in the X direction, and inputs the word vector V1 to the CNN 10. The cycle N is an integer of 2 or more and is half or less of the number of dimensions of the word vector V1.

According to the vectorization device 2 of the present embodiment, the significance is provided for setting a filter region of the CNN 10 so as to internally divide the preprocessed document data D10 in the X direction according to the cycle N in the word vector V1. According to this, it is possible to facilitate language processing by machine learning, such as deepening the CNN 10 to improve performance.

### 1-2. Hardware Configuration

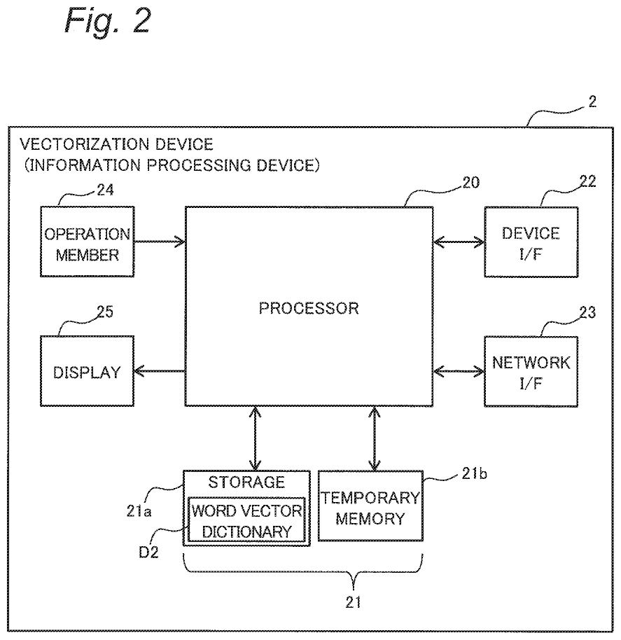

A hardware configuration of the vectorization device 2 according to the present embodiment will be described with reference to FIG. 2. FIG. 2 is a block diagram exemplifying a configuration of the vectorization device 2.

The vectorization device 2 is an information processing device such as a PC or various information terminals. As shown in FIG. 2, the vectorization device 2 includes a processor 20, a memory 21, a device interface 22, and a network interface 23. Hereinafter, “interface” will be abbreviated as “I/F”. Further, the vectorization device 2 also includes an operation member 24 and a display 25.

The processor 20 includes, for example, a CPU or an MPU that realizes a predetermined function in cooperation with software, and controls overall operation of the vectorization device 2. The processor 20 reads out data and a program stored in the memory 21 and performs various types of arithmetic processing to realize various functions. For example, the processor 20 executes the vectorization method of the present embodiment or a program that realizes a language processing method based on the method. The above program may be provided from various communication networks, or may be stored in a portable recording medium.

Note that the processor 20 may be a hardware circuit such as a dedicated electronic circuit or a reconfigurable electronic circuit designed to realize a predetermined function. The processor 20 may be various semiconductor integrated circuits such as a CPU, an MPU, a GPU, a GPGPU, a TPU, a microcomputer, a DSP, an FPGA and an ASIC.

The memory 21 is a storage medium that stores a program and data required to realize a function of the vectorization device 2. As shown in FIG. 2, the memory 21 includes a storage 21a and a temporary memory 21b.

The storage 21a stores a parameter, data, a control program, and the like for realizing a predetermined function. The storage 21a is an HDD or an SSD, for example. For example, the storage 21a stores the word vector dictionary D2 and the like. The word vector dictionary D2 is an example of vectorization information in the present embodiment. The word vector dictionary D2 will be described later.

The temporary memory 21b is a RAM such as a DRAM or an SRAM, for example, and temporarily stores (i.e., holds) data. Further, the temporary memory 21b may function as a work area of the processor 20, or may be a storage area in an internal memory of the processor 20.

The device I/F 22 is a circuit for connecting an external device to the vectorization device 2. The device I/F 22 is an example of an inputter that performs communication according to a predetermined communication standard. The predetermined standard includes USB, HDMI (registered trademark), IEEE1395, WiFi, Bluetooth (registered trademark), and the like.

The network I/F 23 is a circuit for connecting the vectorization device 2 to a communication network via a wireless or wired network. The network I/F 23 is an example of an inputter that performs communication conforming to a predetermined communication standard. The predetermined communication standard includes communication standards such as IEEE802.3 and IEEE802.11a/11b/11g/11ac.

The operation member 24 is a user interface operated by a user. For example, the operation member 24 is a keyboard, a touch pad, a touch panel, a button, a switch, or a combination thereof. The operation member 24 is an example of an inputter that acquires various pieces of information input by the user. Further, the inputter in the vectorization device 2 may be a module to acquire various information by reading the various information stored in various storage media (e.g., the storage 21a) into a work area (e.g., the temporary memory 21b) of the processor 20, for example.

The display 25 is a liquid crystal display or an organic EL display, for example. The display 25 displays various types of information such as information input from the operation member 24 and information indicating a processing result such as document classification by the language processing of the present embodiment.

In the above description, an example of the vectorization device 2 including a PC or the like is described. The vectorization device 2 according to the present disclosure is not limited to this, and may be various information processing devices (i.e., computers). For example, the vectorization device 2 may be one or more server devices such as an ASP server. Further, the language processing method according to the present disclosure may be realized in a computer cluster, cloud computing, or the like.

For example, the vectorization device 2 may acquire the document data D1 (FIG. 1) input from the external device via the communication network by the network I/F 23 and execute vectorization of a text such as a word. The vectorization device 2 may transmit, to the external device, the vectorized document data D10 or a processing result of the CNN 10 for the data D10.

### 1-3. Word Vector Dictionary

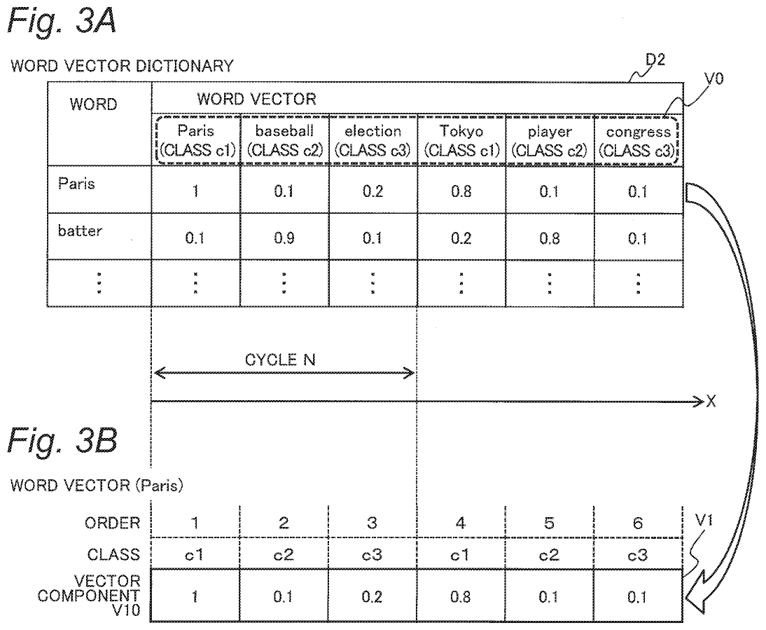

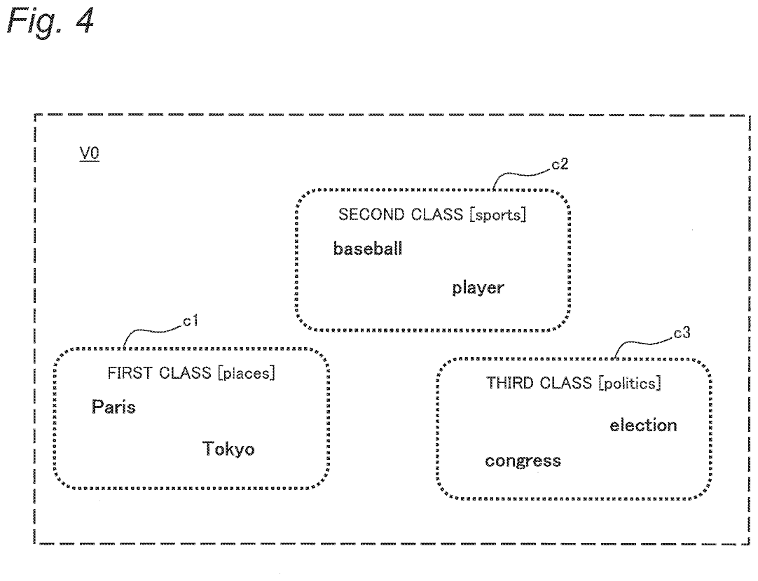

In the present embodiment, the cycle N is realized by using vocabulary classification that provides linguistic meaning to each dimension of the word vector V1 in the word vector dictionary D2, for example. The word vector dictionary D2 and classification of vocabulary will be described with reference to FIGS. 3 and 4.

FIGS. 3A and 3B are diagrams for explaining a data structure of the word vector dictionary D2 in the vectorization device 2. FIG. 4 is a diagram for explaining classification of vocabulary V0 in the word vector dictionary D2.

FIG. 3A shows an example of the word vector dictionary D2. FIG. 3B shows an example of the word vector dictionary D2 in the word vector dictionary D2 of FIG. 3A. FIGS. 3A and 3B show, for simplification of description, an example in which the word vector V1 has six dimensions and the cycle N=3.

The word vector dictionary D2 records a “word” and a “word vector” in association with each other. In the example of FIG. 3A, the word vector V1 corresponding to the word “Paris” and the word vector V1 corresponding to the word “batter” are recorded in the word vector dictionary D2. FIG. 3B exemplifies the word vector V1 of the word “Paris”. Each of the vector components V10 has a value within a predetermined range, such as 0 to 1 or −1 to 1.

The word vector dictionary D2 of the present embodiment is defined by the vocabulary V0 including words as many as dimensions of the word vector V1. In the example of FIG. 3A, the vocabulary V0 of the word vector dictionary D2 includes six words “Paris”, “baseball”, “election”, “Tokyo”, “player” and “parliament”. Each word of the vocabulary V0 is an example of a vocabulary element associated with the vector component V10 of each dimension of the word vector V1.

In the present embodiment, each of the vector components V10 in the word vector V1 indicates similarity, which is the degree whether the word of the word vector V1 and each word of the vocabulary V0 are similar to each other. For example, the first vector component V10 in the word vector V1 indicates the similarity to the first word “Paris” in the vocabulary V0, and the second vector component V10 indicates the similarity to the second word “Baseball” in the vocabulary V0. Thus, in the word vector V1 corresponding to the word “Paris” as shown in FIG. 3B, the first vector component V10 is “1”, while the second vector component V10 is “0.1”.

In the present embodiment, in order to set the cycle N to the word vector V1, words in the vocabulary V0 are classified into N classes. The classification of the vocabulary V0 is described with reference to FIG. 4.

In FIG. 4, words in the vocabulary V0 are classified into first to third classes c1, c2, and c3. The first class c1 is a class to which words related to places belongs. In the example of FIG. 4, the first class c1 includes “Paris” and “Tokyo”. The second class c2 is a class to which words related to sports belong, and includes, e.g., “baseball” and “player”. The third class c3 is a class to which words related to politics belong, and includes, e.g., “election” and “parliament”.

Words of the vocabulary V0 as described above are arranged one by one in order from the first to third classes c1 to c3 in the X direction of the word vector dictionary D2 (FIG. 3A). For example, the first word of the vocabulary V0 in the word vector dictionary D2 is “Paris” belonging to the first class c1, the second word is “baseball” of the second class c2, and the third word is “election” of in the third class c3.

Further, the words of the classes c1 to c3 are arranged in order in each cycle N=3 for the fourth and subsequent words of the vocabulary V0. For example, the fourth word of the vocabulary V0 in the word vector dictionary D2 is “Tokyo”, belonging to the first class c1, and different from the first word “Paris”.

The word vector dictionary D2 manages the order of the vector components V10 arranged in each of the word vectors V1 according to the arrangement order of words in the vocabulary V0 as described above. According to this, in the word vector V1, the vector component V10 indicating the similarity regarding each of the classes c1 to c3 is repeated every cycle N. That is, a set of the N vector components V10 adjacent to each other in the word vector V1, i.e. the N-dimensional subvector, is expected to have a self-completed meaning such as the similarity of the word of the word vector V1 to all of the classes c1 to c3.

As described above, according to the vectorization device 2 of the present embodiment, the meaning of each cycle N can be provided to the word vector V1 from the classification related to the linguistic meaning and managed in the word vector dictionary D2, for example. Note that the classification of the vocabulary V0 is not limited to the linguistic meaning and may be performed from various viewpoints.

### 2. Operation

The language processing method according to the present embodiment and operation of the vectorization device 2 will be described below.

### 2-1. Language Processing Method

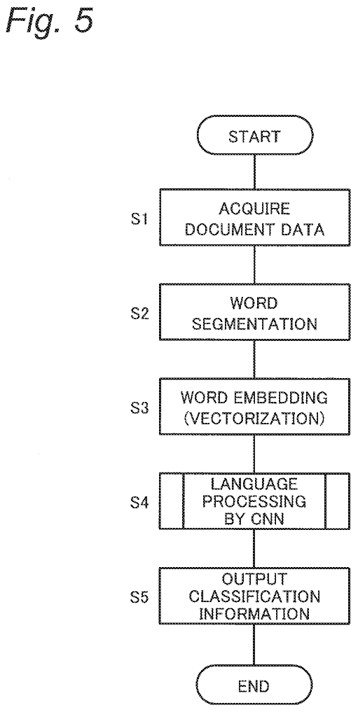

Operation for realizing the language processing method of the present embodiment will be described with reference to FIGS. 1 and 5. Hereinafter, an operation example in which the vectorization device 2 executes the language processing method of the present embodiment is described.

FIG. 5 is a flowchart exemplifying the language processing method according to the present embodiment. Each processing of the flowchart shown in FIG. 5 is executed by the processor 20 of the vectorization device 2.

At first, the processor 20 of the vectorization device 2 acquires the document data D1 (FIG. 1) via any of the various inputters (such as the device interface 22, the network interface 23, and the operation member 24) described above (S1). For example, the user can input the document data D1 by operating the operation member 24.

Next, the processor 20 performs word segmentation so as to recognize a word as a text that is a target of the vectorization in the acquired document data D1 (S2). The processor 20 detects a delimiter of words in the document data D1, such as blank space between words. Further, in a case where a specific part of speech is a processing target of language processing, the processor 20 may extract a word corresponding to the target part of speech from the document data D1.

Next, the processor 20 executes word embedding that is vectorization of a word in the document data D1 as the vectorization device 2 (S3). For example, the processor 20 refers to the word vector dictionary D2 stored in the memory 21 to generate each of the word vectors V1 corresponding to each word.

Further, the processor 20 generates the document data D10 having embedded vectors in place of the words by arranging the word vectors V1 in the Y direction as shown in FIG. 1 in accordance with the order of words recognized in the acquired document data D1. By the processing of Step S3, the cycle N common to the word vectors V1 is set in the X direction of the document data D10 with word embedded vectors.

Next, the processor 20 executes language processing by the CNN 10 based on the generated word vector V1 (S4). For the CNN 10, a specific parameter defining a filter for convolution is set according to the cycle N of the word vector V1 in advance before training of the CNN 10. The processor 20 inputs the document data D10 with word embedded vectors to the CNN 10 trained for document classification for example, to execute processing of document classification by the CNN 10. Details of Step S4 and the CNN 10 will be described later.

Next, the processor 20 outputs, for example, classification information on the document data D1 based on a processing result by the CNN 10 (S5). The classification information indicates a class into which the document data D1 is classified among a plurality of predetermined classes. The processor 20 causes the display 25 to display the classification information, for example.

After outputting the classification information (S5), the processor 20 ends the processing of the flowchart shown in FIG. 5.

According to the above processing, the cycle N is set to the word vector V1 in the language processing by the CNN 10 such as document classification. In this manner, the CNN 10 can be built according to the cycle N of the word vector V1, and thereby the language processing by the learned CNN 10 can be performed accurately.

### 2-1-1. The CNN (Convolutional Neural Network)

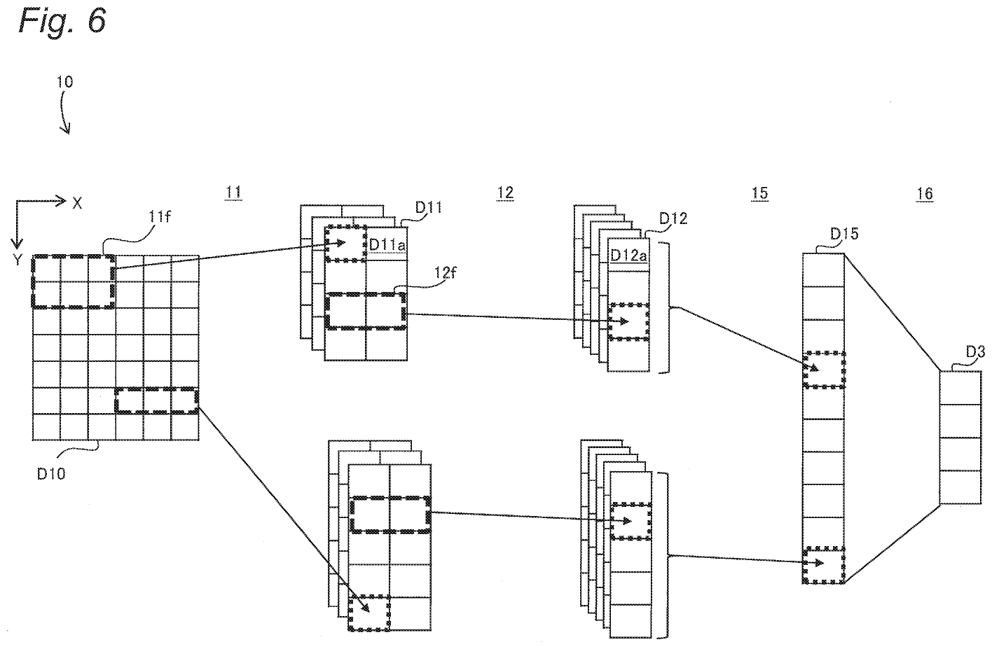

Details of Step S4 and the CNN 10 in FIG. 5 will be described with reference to FIGS. 6, 7, and 8.

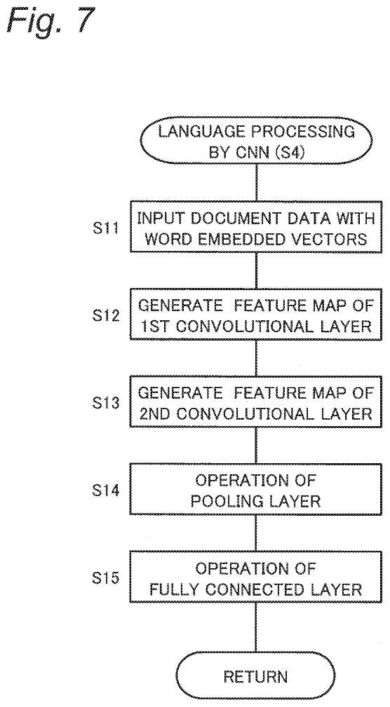

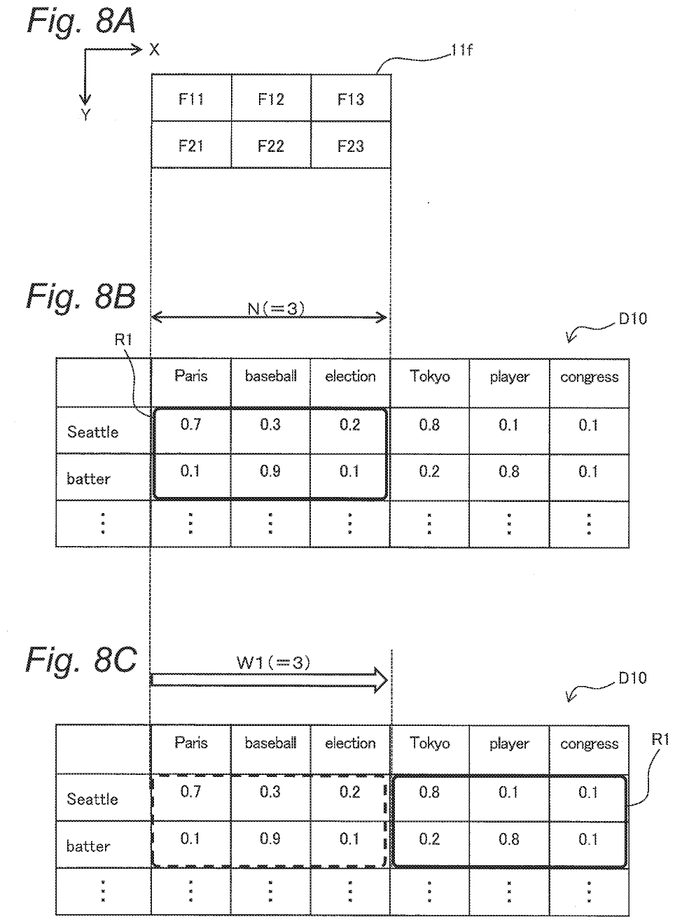

FIG. 6 is a diagram for explaining a network structure of the CNN 10 according to the present embodiment. FIG. 7 is a flowchart for explaining processing of the CNN 10 in the first embodiment. FIGS. 8A to 8C are diagrams for explaining convolution of the CNN 10.

As shown in FIG. 6, the CNN 10 in the present embodiment includes a first convolutional layer 11, a second convolutional layer 12, a pooling layer 15, and a fully connected layer 16 in order from an input side to an output side, for example. Further, the CNN 10 includes an input layer and an output layer for inputting and outputting data, for example. With the CNN 10 including the above layers, processing executed by the processor 20 in Step S4 of FIG. 5 is described with reference to FIG. 7.

At first, as the input layer of the CNN 10, the processor 20 inputs the document data D10 after the vectorization of the words in Step S3 of FIG. 5 to the temporary memory 21b or the like (S11).

Next, as the first convolutional layer 11, the processor 20 performs an operation of convolution on the vectorized document data D10 to generate a feature map D11 (S12). The first convolutional layer 11 performs convolution using a filter 11f having size of an integral multiple of the cycle N and a stride width of an integral multiple of the cycle N (see FIGS. 8A to 8C). According to this, the feature map D11 showing two-dimensional distribution of the feature value D11a is generated. Details of the convolution in the CNN 10 will be described later.

Next, as the second convolutional layer 12, the processor 20 performs convolution of the feature map D11 in the first convolutional layer 11 to generate a new feature map D12 (S13). The feature map D12 in the second convolutional layer 12 may be one-dimensional. Size of a filter 12f and a stride width in the second convolutional layer 12 are not particularly limited and can be set to various values.

Next, the processor 20 performs an operation as the pooling layer 15 based on the generated feature map D12 to generate feature data D15 indicating the operation result (S14). For example, the processor 20 calculates maximum pooling, average pooling, or the like for the feature map D12.

Next, based on the entire generated feature data D15, the processor 20 performs an operation as a fully connected layer 16 to generate output data D3 indicating a processing result by the CNN 10 (S15). For example, the processor 20 calculates activation function for each class of document classification, the activation function obtained by the machine learning for a determination criterion of each class. In this case, each component of the output data D3 corresponds to a degree whether belonging to each class of document classification, for example.

The processor 20 holds the output data D3 generated in Step S15 in the temporary memory 21b as an output layer, and completes the processing of Step S4 in FIG. 5. Then, the processor 20 performs the processing of Step S5 based on the held output data D3.

According to the above processing, the document data D10 processed by the vectorization device 2 is input to the CNN 10 established in accordance with the cycle N of the word vector V1, and thus sequentially convolved in the two convolutional layers 11 and 12 (S12, S13). Details of the convolution in the CNN 10 of the present embodiment is described with reference to FIGS. 8A to 8C.

FIG. 8A shows an example of the filter 11f of the first convolutional layer 11. The filter 11f is defined by a matrix of filter coefficients F11 to F23. The filter coefficients F11 to F23 are set by machine learning to values within a range of 0 to 1, for example.

In the example of FIG. 8A, size of the filter 11f in the X direction is set to three columns according to the cycle N=3. Further, size of the filter 11f in the Y direction is set to 2 rows for two words. The size of the filter 11f in the Y direction is not particularly limited, and may be set to one row corresponding to one word, or may be set to three rows or more.

FIG. 8B shows an example of a filter region R1 with respect to the filter 11f in FIG. 8A. FIG. 8C shows an example of the filter region R1 shifted from the state of FIG. 8B. FIGS. 8B and 8C show an example in which a stride width W1 in the X direction for the convolution is set to three columns according to the cycle N=3.

For example, for the convolution in the first convolutional layer 11, the filter region R1 is set so that the filter 11f is superimposed on the vectorized document data D10 as shown in FIG. 8B. As the first convolutional layer 11, the processor 20 performs weighted sum of corresponding ones of the vector components V10 in the filter region R1 by using the filter coefficients F11 to F23, to obtain a feature value D11a for one filter region R1 (S12).

Further, the processor 20 as the first convolutional layer 11 repeats setting the filter region R1 with shifting the filter 11f for each of the stride width W1 as shown in FIG. 8C for example, and sequentially calculates the feature value D11a for each of the filter regions R1 similarly to the above. As a result, in Step S12 of FIG. 7, the feature map D11 is generated so that the size in the X direction is smaller than the size before the convolution i.e. the document data D10 by an integral multiple of the cycle N.

In the CNN 10 of the present embodiment, the size of the filter 11f and the stride width W1 in the X direction of the first convolutional layer 11 are set to an integral multiple of the cycle N. According to this, the vectorized document data D10 is convoluted so as to be internally divided in the X direction by the filter region R1 with the cycle N as a minimum unit, and thus the feature map D11 can be obtained with the feature value D11a that is considered to have significance according to the cycle N.

The number of the filters 11f in the first convolutional layer 11 may be one or may be plural. The feature maps D11 as many as the number of filters 11f can be obtained. The size of the filter 11f and the stride width can be set separately. The stride width in the Y direction is not particularly limited and can be set as appropriate.

The second convolutional layer 12 has, for example, the filter 12f having size in the X direction of two columns or more as shown in FIG. 6. The processor 20 as the second convolutional layer 12 uses one or more filters 12f to the feature map D11 generated in the first convolutional layer 11 to operate convolution as in Step S12, and calculates a new feature map D12 for each of the filters 12f (S13).

According to the second convolutional layer 12, the feature value D11a for each of the filter regions R1 obtained independently with each word vector V1 internally divided in the first convolutional layer 11 is integrated for size of the filter 12f of the second convolutional layer 12. Thus, an analysis integrated such as so-called ensemble learning can be realized.

Upon training of the above CNN 10 as described above, the same periodicity as the word vector V1 to be input to the trained CNN 10 is set to a word vector for training. For example, the cycle N similar to that of the vectorized document data D1 in Step S3 of FIG. 5 is also set to training data used for the CNN 10. The training data can be created, for example, by using the word vector dictionary D2 or the vectorization device 2 for document data obtained by document classification in advance, for example.

Machine learning of the CNN 10 can be performed by repeating processing similar to that in FIG. 7 with inputs of the above training data in Step S11, and applying an error backpropagation method or the like based on output data of Step S15 and correct classification of the training data. At this time, parameters to be learned such as filter coefficients of each filter, weighting coefficients of the fully connected layer 16, and the like are adjusted while size and a stride width of the filters of the convolutional layers 11 and 12 are determined in advance.

For example, upon machine learning of the CNN 10, each of the feature values D11a of the feature map D11 in the first convolutional layer 11 can be regarded as like a set of weak learners in ensemble learning that independently expresses the property of the filter region R1. Thus, the second convolutional layer 12 can be trained so as to achieve an effect similar to ensemble. That is, with the feature values D11a of the first convolutional layer 11 further integrated, the learning enables to grasp the property of the filter region R1 more deeply.

In the above description, an example in which the number of convolutional layers in the CNN 10 is two, as the first and second convolutional layers 11 and 12, is described. The number of convolutional layers in the CNN 10 of the present embodiment is not limited to two, and may be three or four or more. Further, in the CNN 10 of the present embodiment, a pooling layer or the like may be appropriately provided between the convolutional layers. By increasing the number of layers such as convolutional layers of the CNN 10, the CNN 10 can be deepened and processing accuracy of natural language processing can be improved.

### 2-1-2. Performance Test

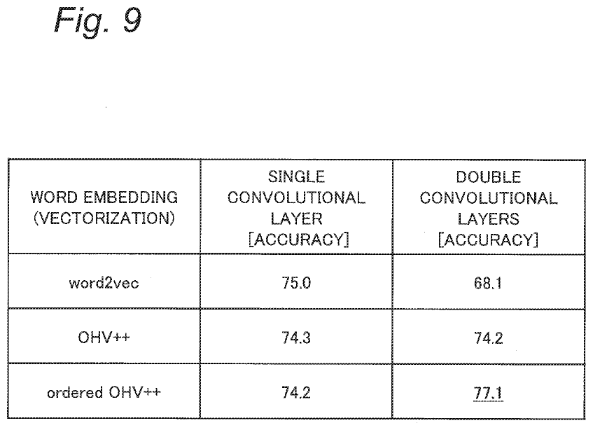

A performance test conducted by the inventor of the present application to experiment on the effect of the language processing method of the present embodiment as described above will be described with reference to FIG. 9. FIG. 9 is a diagram showing an experimental result of the language processing method according to the present embodiment.

As to FIG. 9, the performance test is an experiment for a document classification task. The data used for the experiment is data-web-snippets, which are open data. In the present experiment, a task of classifying documents into eight classes by a CNN is performed.

In the present experiment as shown in FIG. 9, three types of word embedding methods “word2vec”, “OHV++”, and “ordered OHV++” are applied to a CNN having one convolutional layer and a CNN having two convolutional layers. Then, for the above task, respective accuracy and the like are measured.

“Ordered OHV++” indicates a vectorization method by the vectorization device 2 of the present embodiment. A word vector is set to 320 dimensions and the cycle N=8 is set. “OHV++” indicates a vectorization method similar to that of the present embodiment but the periodicity is not provided.

The CNN having two convolutional layers is an example of the CNN 10 shown in FIG. 6 in the present embodiment. In the CNN, size of the filter in the X direction is set to “40” for a first layer and “8” for a second layer. On the other hand, in the CNN with only one convolutional layer, size of the filter in the X direction is set to “320”, which is the same as the number of dimensions of the word vector.

According to the present experiment as shown in FIG. 9, as to “word2vec” and the like, an accuracy in the case of two convolutional layers is lower than that in the case of one convolutional layer. In contrast to this, according to “ordered OHV++” of the present embodiment, an accuracy in the case of two convolutional layers is improved as compared with that in the case of one convolutional layer. In view of the above, it can be checked that the vectorization method of the vectorization device 2 of the present embodiment enables to improve performance of the CNN 10 by deepening.

### 2-2. Calculation Processing of a Word Vector

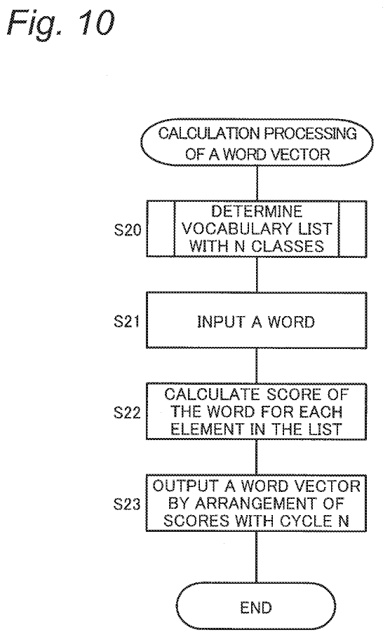

In the above description, an example in which the word vector V1 is generated with reference to the word vector dictionary D2 stored in advance is described. Hereinafter, processing of calculating the word vector V1 in the present embodiment will be described with reference to FIGS. 10, 11, and 12.

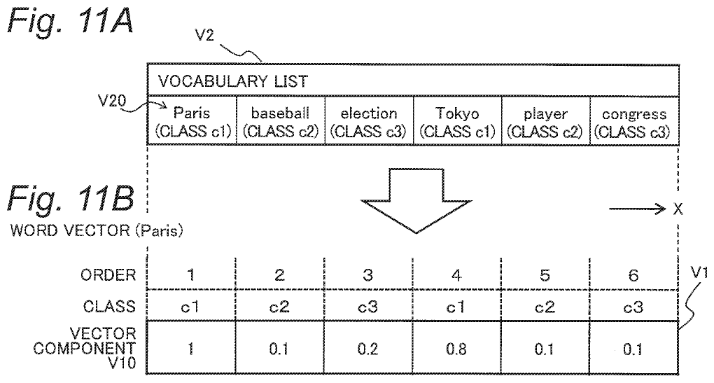

FIG. 10 is a flowchart exemplifying calculation processing of the word vector V1 according to the present embodiment. FIG. 11 is a diagram for explaining the calculation processing of the word vector V1. Hereinafter, an example in which the processor 20 of the vectorization device 2 executes each processing of the flowchart shown in FIG. 10 is described as an example. The processing of the present flowchart starts in a state before the word vector dictionary D2 is created, for example.

At first, the processor 20 determines a vocabulary list with N classes (S20). The vocabulary list is a list that defines vocabulary elements for calculating the word vector V1. FIG. 11A shows an example of a vocabulary list V2.

The vocabulary list V2 in FIG. 11A corresponds to the vocabulary V0 in FIG. 4. In the vocabulary list V2, vocabulary elements of N classes are arranged according to the cycle N. In the example of FIG. 11A, the vocabulary element V20 is a word. Details of the processing (S20) for determining the vocabulary list V2 will be described later. The vocabulary list V2 may be determined in advance.

Returning to FIG. 10, the processor 20 input a word that is a target of the vectorization via any of various inputters (such as the device interface 22, the network interface 23, and the operation member 24) (S21). The processor 20 calculates a score of the input word for each of the vocabulary elements V20 in the vocabulary list V2, by using a predetermined arithmetic expression or the like (S22). For example, the arithmetic expression of the score is stored in the memory 21 in advance, to calculate the similarity between two words. For calculation of the score, pointwise mutual information (PMI) or co-occurrence probability may be used, or matrix decomposition may be used.

The processor 20 arranges the calculated scores in accordance with the arrangement order of the vocabulary elements V20 in the vocabulary list V2, that is, outputs the array of the scores with the cycle N as a word vector (S23). FIG. 11B shows an example of the output word vector V1.

FIG. 11B exemplifies the word vector V1 in a case where the word “Paris” is input in Step S21. The processor 20 calculates a score for each of the vocabulary elements V20 in the vocabulary list V2 of FIG. 11A (S22), and generates the word vector V1 (S23). The processor 20 outputs the word vector V1 to end the flowchart shown in FIG. 10.

According to the above processing, the word vector V1 can be calculated based on the vocabulary list V2 and the like, and thereby the order having the cycle N can be set to the vector components V10. The vocabulary list V2, the arithmetic expression of the score, and the like are examples of vectorization information in the present embodiment.

The word vector dictionary D2 can be created by repeatedly executing the processing of FIG. 10 for a plurality of words.

According to Step S22 described above, a value for each of the vocabulary elements V20 of the word vector V1 is set according to the similarity to the vocabulary element V20 in the vocabulary list V2 or the like. For example, in the word vector V1 of FIG. 11B, while a value “1” is set similarly to so-called a one-hot vector to the vector component V10 for “Paris” which is the same as the word input to the vocabulary element V20, a non-zero value is also set to the other vector components V10. According to this, sparseness such as the one-hot vector can be resolved, and data that is easy to utilize in machine learning can be obtained.

As the score calculation method in Step S22, another word embedding method may be used to generate a vector in an intermediate state different from the word vector V1 output in Step S23. For example, the processor 20 can generate a vector corresponding to a word in the vocabulary list V2 and a vector corresponding to an input word in word2vec or the like, and calculate the inner product of the generated vectors as the score.

In the above description, the example in which the vocabulary element V20 constituting the vocabulary list V2 is a word is described. The vocabulary element V20 is not limited to a word and may be various elements, e.g., a document and the like. For example, in Step S22, the processor 20 may calculate a score of a corresponding vector component by counting target words in a document that is a vocabulary element.

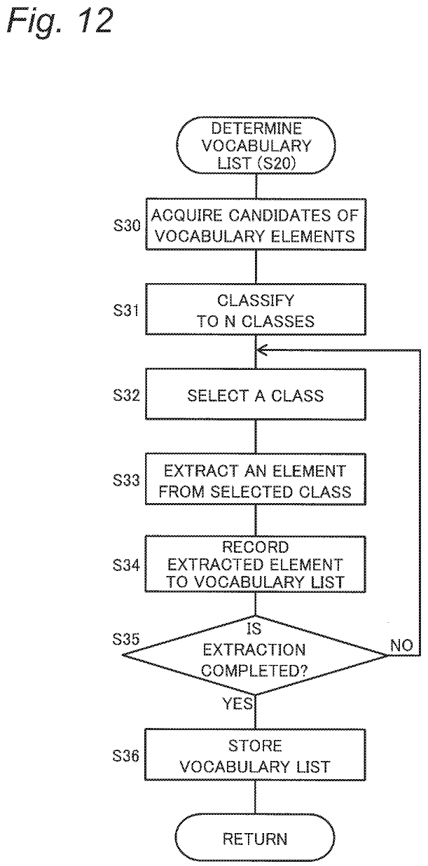

The processing of Step S20 of FIG. 10 will be described with reference to FIG. 12. FIG. 12 is a flowchart exemplifying the processing (S20) of determining the vocabulary list V2.

At first, the processor 20 acquires information, such as a word group or a document group including candidates of the vocabulary elements V20 in the vocabulary list V2 via any of various inputters (such as the device interface 22, the network interface 23, and the operation member 24) (S30). For example, the information acquired in Step S30 may be predetermined training data.

Next, the processor 20 classifies elements such as words indicated by the acquired information, into classes which are as many as the cycle N (S31). The processing of Step S31 can use various classification methods such as the K-means method or the latent Dirichlet distribution method (LDA). As a class of the vocabulary V0, for example, the same class as a document classification by the CNN 10 may be used, or a class different from the document classification may be used.

Next, the processor 20 selects one of N classes in order from a first class (S32). The processor 20 extracts one element such as a word in the selected class as the vocabulary element V20 (S33). The processor 20 records the extracted vocabulary element V20 to the vocabulary list V2, for example, in the temporary memory 21b (S34).

The processor 20 repeats the processing of Steps S32 to S35 until the number of the vocabulary elements V20 in the vocabulary list V2 reaches a predetermined number (NO in S35). The predetermined number indicates the number of dimensions of a desired word vector. In each Step S32, the processor 20 performs selection sequentially from a first class to an N-th class, with the first class selected after the N-th class. Further, the processor 20 sequentially records the vocabulary elements V20 extracted in each Step S33 to the vocabulary list V2 in Step S34.

When the number of the vocabulary elements V20 in the vocabulary list V2 reaches a predetermined number (YES in S35), the processor 20 stores, for example, the vocabulary list V2 in the storage 21a (S36). Then, the processor 20 ends the processing of Step S20 of FIG. 10 and proceeds to Step S21.

According to the above processing, by classifying candidates of the vocabulary element V20 into the N classes, and extracting the vocabulary element V20 sequentially from each class, the vocabulary list V2 having the cycle N can be generated.

For extracting the vocabulary element V20 in Step S33, an inverse document frequency (iDF) may be used as an example. For example, when a word as the vocabulary element V20 is extracted, the processor 20 calculates, for each word, a difference between an iDF in the information acquired in Step S30 and an iDF in the class selected in Step S32. The processor 20 sequentially extracts words in order from one having a largest difference in each class (S33). In this manner, a representative word that is considered to appear characteristically in each class can be extracted as the vocabulary element V20.

### 3. Summary

As described above, the vectorization device 2 according to the present embodiment generates the word vector V1 which is a vector corresponding to a text of each word. The vectorization device 2 includes inputters (such as the device interface 22, the network interface 23, and the operation member 24), the memory 21, and the processor 20. The inputter acquires a text such as a word (S1). The memory 21 stores the word vector dictionary D2 and the like as an example of vectorization information indicating correspondence between a text and a vector. The processor 20 generates the word vector V1 corresponding to the acquired word based on the vectorization information (S3). The vectorization information sets order having a predetermined cycle N to a plurality of the vector components V10 included in each of the word vectors V1.

According to the vectorization device 2 described above, by providing each of the word vectors V1 with internal periodicity, it is possible to provide the significance of the local filter region R1 of the CNN 10 and to facilitate the language processing by the CNN 10, for example.

In the present embodiment, the vectorization information such as the word vector dictionary D2 is defined by a plurality of the vocabulary elements V20 corresponding to the plurality of the vector components V10 in the word vector V1. The vocabulary element V20 is classified into N classes as many as the vector components V10 in the cycles N. The vectorization information sets the above order to arrange the vocabulary elements V20 with each of the classes repeated per the cycles N. According to this, the filter region R1 having a similar property can be repeatedly formed for each of the cycles N, and the word vector V1 can be easily utilized in the CNN 10 or the like.

In the present embodiment, each of the vector components V10 of the word vector V1 corresponding to a word indicates a score for each of the vocabulary elements V20 regarding the word. According to such scores of each of the vocabulary elements V20, non-zero values are set to a large number of the vector components V10, so that sparsity can be avoided.

In the present embodiment, classes c1 to c3 of the vocabulary V0 indicate classification of the vocabulary element V20 based on linguistic meaning. According to this, it is possible to make sense to the cycle N of the word vector V1 from the viewpoint of the linguistic meaning.

In the present embodiment, the processor 20 executes language processing by the CNN 10 based on the generated word vector V1 (S4). The CNN 10 has the filter 11f and the stride width W1 according to the cycle N. In this manner, the language processing by the CNN 10 can be performed accurately according to the cycle N of the word vector V.

In the present embodiment, the CNN 10 includes the first convolutional layer 11 that calculates convolution based on the filter 11f having size that is an integer multiple of the cycle N and the stride width W1 that is an integer multiple of the cycle N, and the second convolutional layer 12 that convolutes a calculation result of the first convolutional layer 11. Accordingly, the CNN 10 for language processing can perform language processing accurately using a plurality of the convolutional layers 11 and 12. The CNN 10 may include an additional convolutional layer and the like.

The language processing method in the present embodiment is a method in which a computer such as the vectorization device 2 performs language processing based on a text. The present method includes the step (S1) in which the computer acquires a text, and the step (S3) in which the processor 20 of the computer generates a vector corresponding to the acquired text based on vectorization information indicating correspondence between a text and a vector. The present method includes the step (S4) in which the processor 20 executes language processing by the CNN 10 based on the generated vector. The processor 20 sets the order having a predetermined cycle N to a plurality of vector components included in each vector based on the vectorization information, and inputs the generated vector to the CNN 10 (S11).

According to the language processing method described above, providing a vector with periodicity enables to facilitate the language processing using a vector according to a text. In the present embodiment, a program for causing a computer to execute the language processing method is provided. The above program may be stored and provided in various a non-transitory computer-readable recording medium. By causing a computer to execute the program, language processing can be easily performed.

### Other Embodiments

As described above, the first embodiment has been described as an example of the technique disclosed in the present application. However, the technique in the present disclosure is not limited to this, and is also applicable to an embodiment in which changes, replacements, additions, omissions, and the like are appropriately made. Further, the constituents described in each of the above-described embodiments can also be combined to form a new embodiment. In view of the above, other embodiments will be exemplified below.

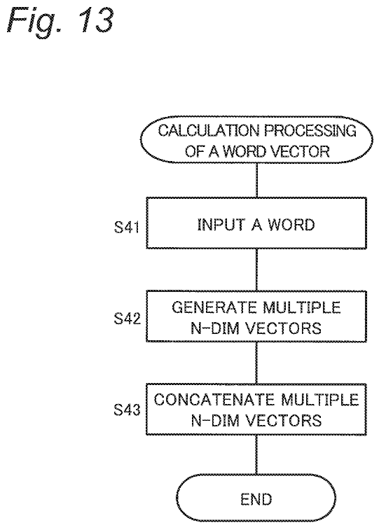

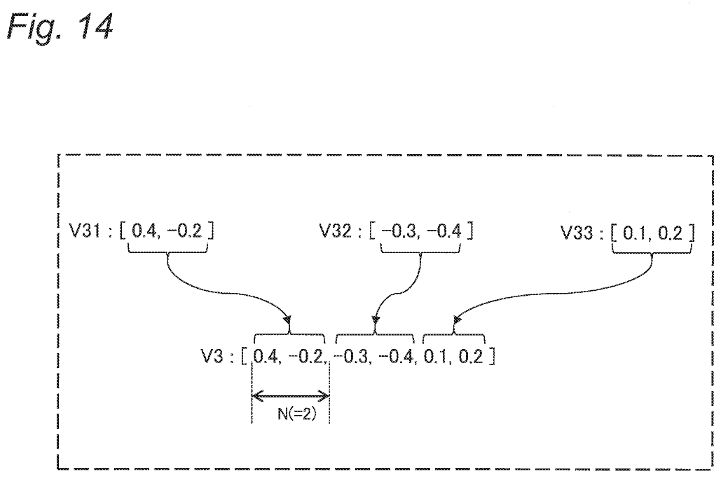

In the above first embodiment, the word vector V1 has periodicity based on the vocabulary V0. A variation in which a word vector has periodicity without using the vocabulary V0 will be described with reference to FIGS. 13 and 14.

FIG. 13 is a flowchart for explaining a variation of calculation processing of a word vector V3. FIG. 14 is a diagram for explaining the variation of the calculation processing of the word vector V3. At first, the processor 20 of the vectorization device 2 inputs a word to be processed, as in Step S21 of FIG. 10 (S41).

Next, the processor 20 generates a plurality of N-dimensional vectors which are independent of each other, based on the input word (S42). FIG. 14 shows an example in which three N-dimensional vectors V31, V32, V33 are generated in the case of N=2. For example, the processing of Step S42 can be performed using various word embedding methods such as Word2Vec and GloVe. For example, the processing of Step S42 may be performed such that a plurality of learning models are independently learned in advance and each learning model generates an N-dimensional vector corresponding to the word input in Step S41.

Next, as shown in FIG. 14 for example, the processor 20 concatenates the calculated N-dimensional vectors 31 to 33 to calculate one word vector V3 (S43). The above processing also allows to set the cycle N in the calculated word vector V3 according to each N-dimensional vector. A word vector dictionary based on the word vector calculated as described above may be used.

In each of the above embodiments, an example in which a word is a target to be processed into a word vector by the vectorization device 2 has been described. However, the target to be processed is not limited to a word and may be various text. The text to be processed by the vectorization device of the present embodiment may include at least one of a character, a word, a phrase, a sentence, and a document. For the vectorization of a character for example, a predetermined plural number of characters may be used as a processing unit. For the vectorization of the various text, setting the cycle N similarly to the above can facilitate language processing based on a vector corresponding to the text.

In each of the above-described embodiments, the CNN 10 is used for the language processing with a vector generated according to a text, but the CNN does not need to be used. Data obtained by the vectorization of a text with the cycle N may be used for language processing different from a CNN.

In each of the above embodiments, document classification has been described as an example of language processing. The language processing method of the present embodiment may be applied to various language processing without limitation to document classification, and may be applied to machine translation, for example.

As described above, the embodiment has been described as an example of the technique in the present disclosure. For that purpose, the accompanying drawings and the detailed description are provided.

Therefore, among the constituent elements described in the accompanying drawings and the detailed description, not only the constituent elements that are essential for solving the problem, but also the constituent elements that are not essential for solving the problem may also be included in order to illustrate the above technique. Therefore, it should not be immediately acknowledged that the above non-essential constituent elements are essential based on the fact that the non-essential constituent elements are described in the accompanying drawings and the detailed description.

Further, since the above-described embodiment is for exemplifying the technique in the present disclosure, various changes, substitutions, additions, omissions, and the like can be made within the scope of claims or a scope equivalent to the claims.

### INDUSTRIAL APPLICABILITY

The present disclosure is applicable to various types of natural language processing such as various document classifications and machine translation.

1. A vectorization device that generates a vector according to a text, comprising:
an inputter that acquires a text;
a memory that stores vectorization information indicating correspondence between a text and a vector; and
a processor that generates a vector corresponding to an acquired text based on the vectorization information, wherein
the vectorization information sets order having a predetermined cycle to a plurality of vector components included in a generated vector.

2. The vectorization device according to claim 1, wherein
the vectorization information is defined by a plurality of vocabulary elements corresponding to the plurality of vector components in the generated vector,
the vocabulary element is classified into a number of classes, the number corresponding to the cycle, and
the vectorization information sets the order to arrange the vocabulary elements with each of the classes repeated per the cycle.

3. The vectorization device according to claim 2, wherein each vector component in a vector corresponding to the text indicates a score for each of the vocabulary elements.

4. The vectorization device according to claim 2, wherein the classes indicate classification of the vocabulary elements based on linguistic meaning.

5. The vectorization device according to claim 1, wherein the text includes at least one of a character, a word, a phrase, a sentence, and a document.

6. The vectorization device according to claim 1, wherein the processor executes language processing by a convolutional neural network based on the generated vector, the convolutional neural network having a filter and a stride width according to the cycle.

7. The vectorization device according to claim 6, wherein
the convolutional neural network includes:
a first convolutional layer that calculates convolution based on the filter and the stride width, the filter having size that is an integer multiple of the cycle, and the stride width being an integer multiple of the cycle; and
a second convolutional layer that convolutes a calculation result of the first convolutional layer.

8. A language processing method for a computer to perform language processing based on a text, the language processing method comprising:
acquiring, by the computer, a text;
generating, by a processor of the computer, a vector corresponding to an acquired text based on vectorization information indicating correspondence between a text and a vector; and
executing, by the processor, language processing by a convolutional neural network based on a generated vector, wherein
the processor sets order having a predetermined cycle to a plurality of vector components included in a generated vector based on the vectorization information, to input the generated vector to the convolutional neural network.

9. A non-transitory computer-readable recording medium storing a program for causing a computer to execute the language processing method according to claim 8.
